(19) United States
(12) Patent Application Publication
(10) Pub. No.: US 2025/0076510 A1
(43) Pub. Date: Mar. 6, 2025

(54) LIGHT DETECTION AND RANGING (LIDAR) POINT CLOUD STITCHING

(71) Applicant: GM Cruise Holdings LLC, San Francisco, CA (US)

(72) Inventors: Andres Hasfura, Oakland, CA (US); John Arendt, Austin, TX (US)

(21) Appl. No.: 18/460,162

(22) Filed: Sep. 1, 2023

(51) Int. Cl. G01S 17/931; G01S 7/497; G01S 17/89

(52) U.S. Cl. CPC G01S 17/931; G01S 7/497; G01S 17/89

(57) ABSTRACT

Systems and techniques are provided for implementing LiDAR point cloud stitching. An example method includes determining a visibility grid that is based on a plurality of measurements from a first LiDAR device, wherein the visibility grid includes a plurality of range values corresponding to a field of view of the first LiDAR device; identifying, based on the visibility grid, at least one occluded region in the field of view; and modifying a point cloud that is based on the plurality of measurements to include additional points corresponding to one or more measurements obtained from a second LiDAR device, wherein the one or more measurements correspond to the at least one occluded region.

### BACKGROUND

### 1. Technical Field

The present disclosure generally relates to autonomous vehicles and, more specifically, to stitching point clouds that are generated by Light Detection and Ranging (LiDAR) sensors used by autonomous vehicles.

### 2. Introduction

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, an image sensor can be used to capture frames (e.g., video frames and/or still pictures/images) depicting a target(s) from any electronic device equipped with an image sensor. As another example, a light detection and ranging (LiDAR) sensor can be used to determine ranges (variable distance) of one or more targets by directing a laser to a surface of an entity (e.g., a person, an object, a structure, an animal, etc.) and measuring the time for light reflected from the surface to return to the LiDAR.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, according to some examples of the present disclosure;

FIG. 2 is a diagram illustrating an example system for implementing Light Detection and Ranging (LiDAR) point cloud stitching, according to some examples of the present disclosure;

FIG. 3 is a diagram illustrating another example system for implementing LiDAR point cloud stitching, according to some examples of the present disclosure;

FIG. 4A and FIG. 4B illustrate examples of visibility grids that may be used to perform LiDAR point cloud stitching, according to some examples of the present disclosure;

FIG. 5 is a flowchart illustrating an example process for performing LiDAR point cloud stitching, according to some examples of the present disclosure; and

FIG. 6 is a diagram illustrating an example system architecture for implementing certain aspects described herein, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Generally, sensors are integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, an image sensor can be used to capture frames (e.g., video frames and/or still pictures/images) depicting a target(s) from any electronic device equipped with an image sensor. As another example, a light detection and ranging (LiDAR) sensor can be used to determine ranges (variable distance) of one or more targets by directing a laser to a surface of an entity (e.g., a person, an object, a structure, an animal, etc.) and measuring the time of flight (e.g., time to receive reflection corresponding to LiDAR transmission). In a LiDAR system, a LiDAR sensor emits light waves (laser signals) from a laser into the environment. The laser signals can reflect off the surface of surrounding objects and return to the LiDAR sensor, which can use the return signal to determine ranges and/or intensity parameters.

In some cases, the visibility of LiDAR sensors may be impaired due to the presence of objects. For example, an object in the near field of the field of view of a LiDAR sensor may create an occluded region that results in a shadow in the corresponding LiDAR point cloud. In some examples, such occlusions may prevent or delay detection of objects or persons.

In some configurations, a system may be designed to mitigate against such occlusions by including multiple LiDAR sensors. That is, an area that is occluded from a first LiDAR sensor may be visible to a second LiDAR sensor because the LiDAR sensors are at different positions. LiDAR point cloud stitching may then be used to combine the point cloud from the first LiDAR device with the point cloud from the second LiDAR device in order to obtain additional coverage and mitigate against potential occlusions. However, the wholesale combination of LiDAR point clouds can introduce new problems such as motion artifacts. That is, relative motion between the LiDAR devices and a detected object can cause motion artifacts that reduce the precision of object detections. Also, combining the entire point cloud from multiple LiDAR devices can be burdensome due to the computational load and can also delay object detections, which in turn delays route planning decisions made by an autonomous vehicle, for example.

Systems, apparatuses, processes (also referred to as methods), and computer-readable media (collectively referred to as “systems and techniques”) are described herein for implementing LiDAR point cloud stitching. In some aspects, a visibility grid can be used to determine the range of a first LiDAR device with different areas of its field of view. In some examples, the visibility grid can be used to determine if there is an occlusion within the field of view (e.g., the first LiDAR device has limited range at a certain azimuth or elevation). In some cases, a visibility grid can be used to determine if a second LiDAR device has better visibility in the area that is occluded from the first LiDAR device. In some examples, LiDAR point cloud stitching can be implemented such that LiDAR points are intelligently selected for inclusion in the point cloud. For example, the LiDAR point cloud from the first LiDAR device can be supplemented with LiDAR points from the second LiDAR device that correspond to the occluded region.

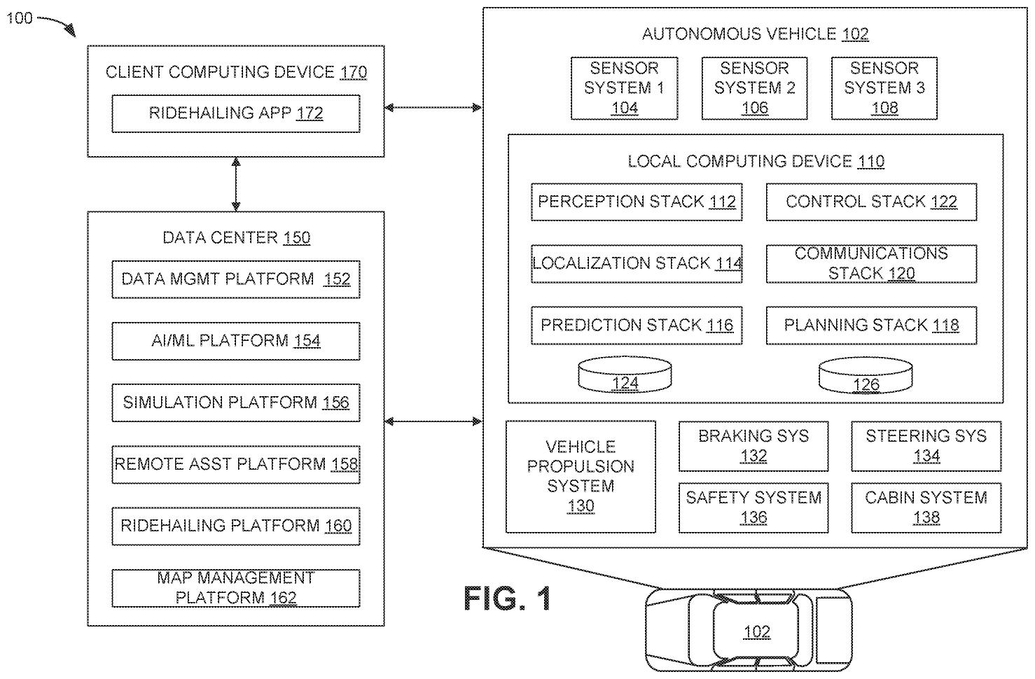

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls layer can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 to enable passengers to view the AV 102 in transit en route to a pick-up or drop-off location, and so on.

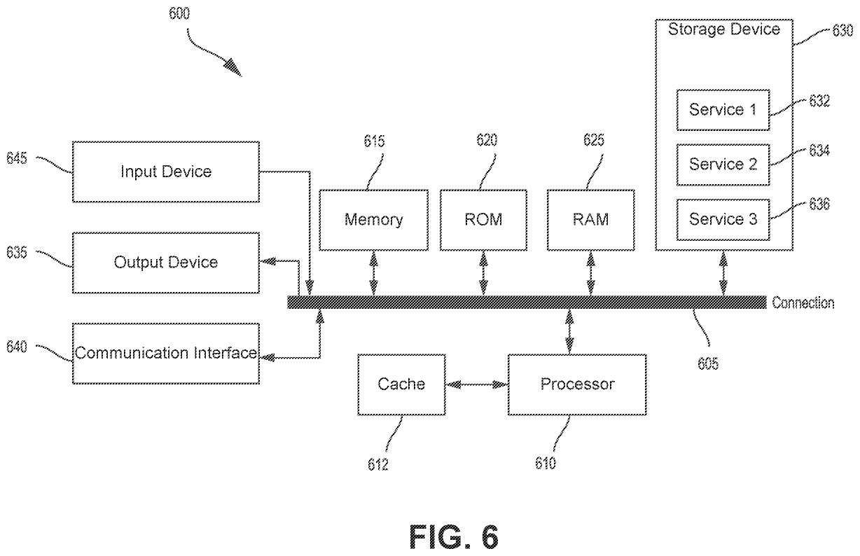

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

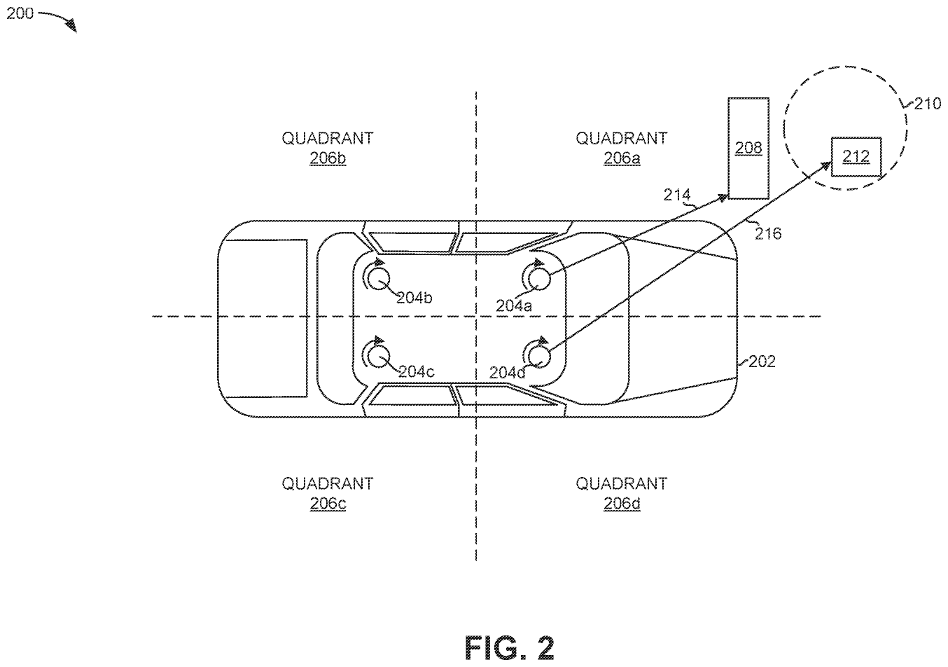

FIG. 2 is a diagram illustrating an example system 200 that may be used to perform LiDAR point cloud stitching, according to some examples of the present disclosure. In some cases, the system 200 can include an autonomous vehicle (AV) such as AV 202. In some examples, AV 202 may correspond to AV 102, as illustrated in FIG. 1. In some configurations, AV 202 can include one or more sensors such as LiDAR 204a, LiDAR 204b, LiDAR 204c, and LiDAR 204d (collectively “LiDARs 204”). In some aspects, LiDARs 204 may correspond to a LiDAR sensor that is used as part of sensor systems 104-108. In some instances, LiDARs 204 may include a rotating or spinning LiDAR sensor that is capable of capturing a 360-degree field of view. In some cases, LiDARs 204 may include a scanning LiDAR sensor that is fixed in place and is directed in a single direction with a limited field of view.

In some examples, one or more areas, zones, or regions within a space can be assigned to a LiDAR device. In some cases, the area, zone, or region that is assigned to a LiDAR device may correspond to a portion of the field of view of the LiDAR device. For example, an assigned zone may include a portion of the 360-degree field of view of a spinning LiDAR device. As illustrated, LiDAR 204a can be assigned to quadrant 206a; LiDAR 204b can be assigned to quadrant 206b; LiDAR 204c can be assigned to quadrant 206c; and LiDAR 204d can be assigned to quadrant 206d. In some cases, filtering the points from LiDARs 204 based on an assigned zone (e.g., quadrant 206a, quadrant 206b, quadrant 206c, and/or quadrant 206d) can help reduce motion artifacts (e.g., caused by detecting a moving object at different times by different LiDAR devices). In some cases, filtering the points from LiDARs 204 based on an assigned zone can reduce latency that may be caused by processing all of the points from LiDARs 204.

In some aspects, a point cloud for the entire area surrounding AV 202 can be generated by stitching together points collected by LiDARs 204 from their respective quadrants. For example, the point cloud may be stitched together by combining points detected by LiDAR 204a in quadrant 206a, points detected by LiDAR 204b in quadrant 206b, points detected by LiDAR 204c in quadrant 206c, and points detected by LiDAR 204d in quadrant 206d. That is, LiDAR stitching can be performed to combine data collected by two or more LiDAR devices. All or a portion of a point cloud that is generated based on data collected by one LiDAR device can be combined with all or a portion of a point cloud that is generated based on data that is collected by another LiDAR device.

In some aspects, LiDAR stitching may be done to compensate for regions that are outside the field of view of a LiDAR device. For instance, a stitched LiDAR point cloud may include all of the points that are within the region that is assigned to a LiDAR device (e.g., all points collected by LiDAR 204a that are within quadrant 206a). In some aspects, the stitched LiDAR point cloud may include points collected by LiDAR devices that are not assigned to a region when those points are outside the field of view of the LiDAR device that is assigned to the region. For example, a stitched LiDAR point cloud may include points collected by LiDAR 204c that are within quadrant 206d when those points are outside the field of view of LiDAR 204d.

In some cases, LiDAR stitching may be done to compensate for shadows or regions that may be occluded to one LiDAR device but may be visible to another LiDAR device. For example, as illustrated in FIG. 2, object 208 may create an occluded region 210 that is not visible to LiDAR 204a. That is, LiDAR 204a can detect object 208 using LiDAR beam 214. However, in some aspects, LiDAR 204a cannot detect object 212 within occluded region 210 because LiDAR beams that are transmitted by LiDAR 204a in the direction of occluded region 210 are reflected from object 208. Consequently, the point cloud that is generated using the data collected by LiDAR 204a can include a shadow in the area corresponding to occluded region 210 (e.g., LiDAR 204a will not detect object 212).

In some cases, data collected by a second LiDAR device can be used to compensate for shadows or regions that are occluded. For instance, as illustrated in FIG. 2, LiDAR 204d can detect object 212 within occluded region 210 using LiDAR beam 216. In some aspects, data collected by LiDAR 204d that corresponds to occluded region 210 can be used to supplement the LiDAR point cloud generated by LiDAR 204a. That is, points collected by LiDAR 204d that correspond to occluded region 210 can be added to the stitched point cloud even though that are not within the quadrant (e.g., quadrant 206d) that is assigned to LiDAR 204d.

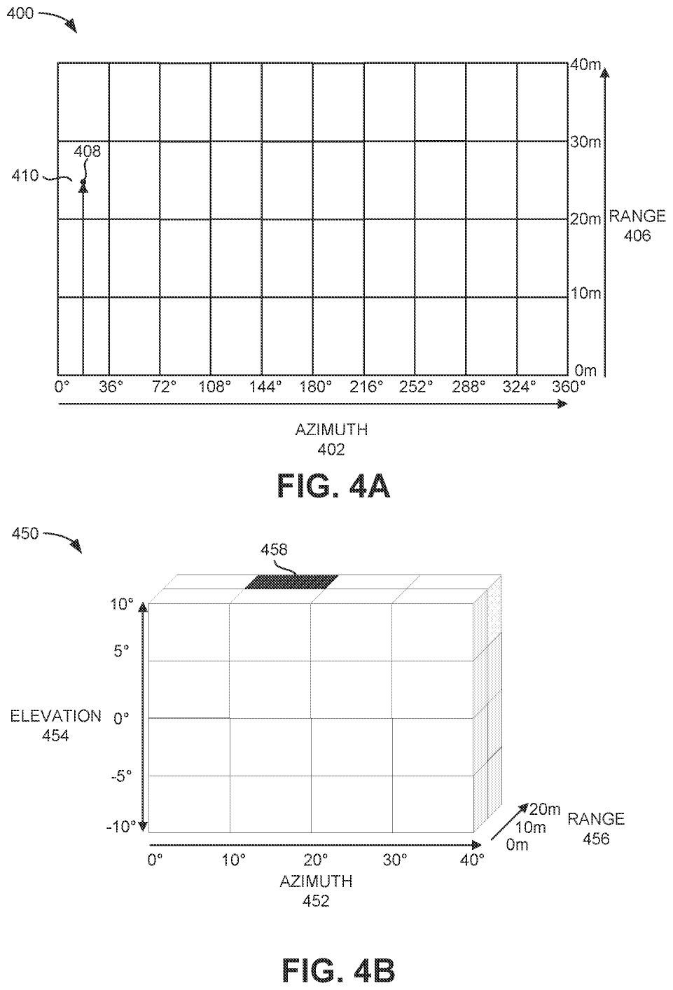

In some examples, LiDAR point cloud stitching can be implemented based on a visibility grid that can be used to identify the range of a LiDAR device within a particular region. For example, a two-dimensional visibility grid may indicate the range of a LiDAR device at a given azimuth. In another example, a three-dimensional visibility grid may indicate the range of a LiDAR device at a given azimuth and elevation. Further discussion relating to visibility grids is included below with respect to FIG. 4A and FIG. 4B.

With respect to FIG. 2, a visibility grid corresponding to LiDAR 204a may indicate that LiDAR 204a has reduced visibility in the area corresponding to occluded region 210. That is, the visibility grid may indicate that the range at the azimuth and/or elevation corresponding to occluded region 210 is less than an expected threshold range value. In some aspects, points from the other LiDAR devices (e.g., LiDAR 204b, LiDAR 204c, and/or LiDAR 204d) may be tested to determine whether they fall inside the occluded region 210. For example, a point corresponding to LiDAR beam 216 falls within occluded region 210 and may therefore be added to the fused point cloud.

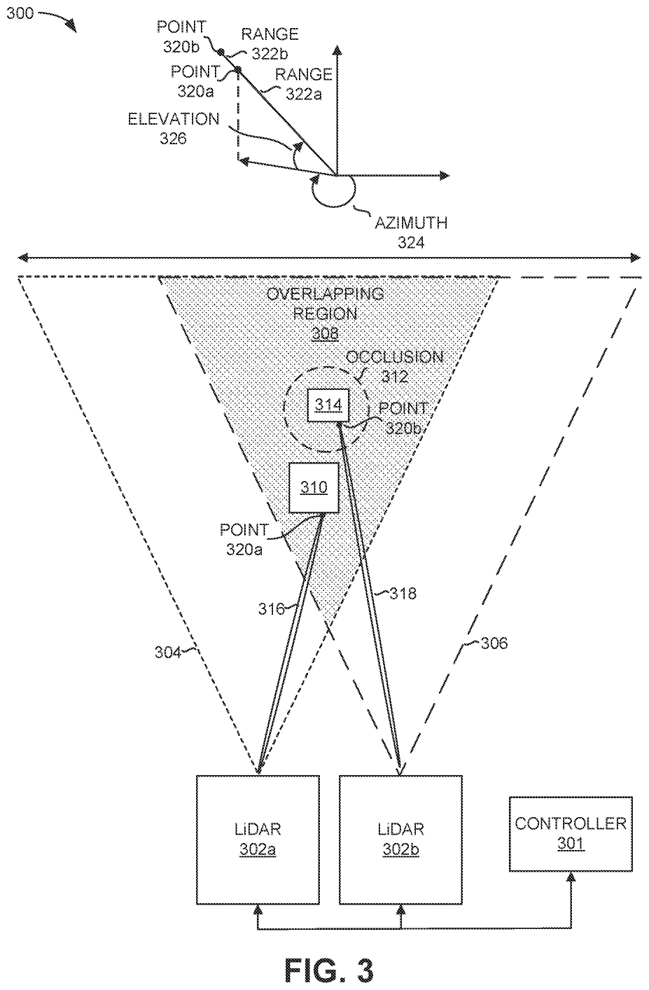

FIG. 3 is a diagram illustrating an example system 300 that may be used to perform LiDAR point cloud stitching, according to some examples of the present disclosure. In some cases, system 300 may include a controller 301 that is coupled to one or more LiDAR devices such as LiDAR 302a and LiDAR 302b. In some aspects, controller 301 may correspond to a component within local computing device 110 (e.g., a processor, a graphics processing unit (GPU), an application-specific integrated circuit (ASIC), etc.).

As noted with respect to LiDARs 204 in FIG. 2, LiDAR 302a and/or LiDAR 302b may correspond to a rotating LiDAR device (e.g., having a 360-degree field of view) or a scanning LiDAR device (e.g., having a fixed field of view). As illustrated, LiDAR 302a may have field of view (FoV) 304 and LiDAR 302b may have FoV 306. In some cases, FoV 304 can overlap with FoV 306 at overlapping region 308.

In some examples, object 310 may be located within overlapping region 308 (e.g., within FoV 304 of LiDAR 302a and within FoV 306 of LiDAR 302b). In some aspects, LiDAR 302a may detect object 310 (e.g., using LiDAR beam 316). In some configurations, object 310 may create an occlusion 312 that prevents LiDAR 302a from detecting object 314. In some cases, a point cloud that is generated based on data collected by LiDAR 302a may include a shadow in the area corresponding to occlusion 312.

In some aspects, LiDAR 302b can detect object 314 (e.g., using LiDAR beam 318) that is within the area that is occluded from LiDAR 302a (e.g., within occlusion 312). In some instances, the point cloud corresponding to LiDAR 302a can be supplemented with points that are detected by LiDAR 302b to compensate or cover occlusion 312. That is, LiDAR point cloud stitching can be used to combine points from LiDAR 302b that correspond to occlusion 312 (e.g., point 320b) with the points detected by LiDAR 302a (e.g., point 320a).

In some examples, a visibility grid can be populated for LiDAR 302a and/or LiDAR 302b that indicates a range of the corresponding LiDAR device for different areas within the FoV (e.g., FoV 304 of LiDAR 302a and/or FoV 306 of LiDAR 302b). In some aspects, the visibility grid can include multiple grids or segments that correspond to different portions of the FoV of a LiDAR device. For instance, a two-dimensional visibility grid may segment the FoV of a LiDAR device based on a range of values for an azimuth parameter and a range of values for a range parameter. In another example, a three-dimensional visibility grid may segment the FoV of a LiDAR device based on a range of values for an azimuth parameter, a range of values for an elevation parameter, and a range of values for a range parameter.

In some cases, the visibility grid corresponding to LiDAR 302a may indicate that LiDAR 302a has reduced visibility in the area corresponding to occlusion 312. For example, the visibility grid corresponding to LiDAR 302a may indicate that point 320a, which corresponds to azimuth 324 and elevation 326, has a range value corresponding to range 322a. In another example, the visibility grid corresponding to LiDAR 302b may indicate that point 320b corresponds to the same azimuth and elevation as point 320b (e.g., azimuth 324 and elevation 326) but has a range of value corresponding to range 322b, which is greater than range 322a. In some cases, point 320b may be stitched to the point cloud for LiDAR 302a because LiDAR 302a has greater visibility in the respective area (e.g., area corresponding to occlusion 312).

In some examples, controller 301 may translate LiDAR points to a common location or reference point. For example, in the case of an autonomous vehicle (e.g., AV 202), LiDAR points may be adjusted to a common reference point corresponding to the center of a rear axle or to some other common reference point on the vehicle (e.g., quadrant origin for quadrant 206a, quadrant 206b, quadrant 206c, and quadrant 206d). In some cases, in which LiDAR points have been adjusted to a common reference point, the LiDAR points may be translated back to a reference point corresponding to the center of the LiDAR device prior to generating the visibility grid or to some other reference point on the vehicle. For example, point 320a may be translated to be relative to the center of LiDAR 302a and point 320b may be translated to be relative to the center of LiDAR 302b. In some instances, the translation of a LiDAR point p may be implemented using the following equation, which computes a vector v spanning from the LiDAR center l (e.g., relative to the common reference point such as the center of the rear axle) to the LiDAR point.

$$v = p - l \qquad ( 1 )$$

In some aspects, the magnitude of the vector v can be computed as follows:

$$v = ‖ p - l ‖ \qquad ( 2 )$$

In some cases, the horizontal azimuth On (e.g., azimuth 324) can be computed using the following equation, which yields the horizontal angle between the point and the LiDAR.

$${θ}_{h} = {tan}^{- 1} ( v \cdot y / v \cdot x ) \qquad ( 3 )$$

In some instances, the vertical azimuth θᵥ (e.g., elevation 326) can be computed using the following equation, which yields the vertical angle between the point and the LiDAR.

$${θ}_{v} = {sin}^{- 1} ( v \cdot z / m ) \qquad ( 4 )$$

In some examples, discretized indices for each component of the visibility grid can be determined using the following equation.

$${I}_{r} {I}_{h} {I}_{v} = Bin ( m , {θ}_{h} , {θ}_{v} ) \qquad ( 5 )$$

FIG. 4A illustrates an example of a visibility grid 400, according to some aspects of the present disclosure. As illustrated, visibility grid 400 is a two-dimensional visibility grid in which each grid element corresponds to a range of azimuth values (e.g., azimuth 402) and a range of range values (e.g., range 406). For example, element 410 within visibility grid 400 corresponds to values of azimuth 402 that are from 0 degrees to 36 degrees and values of range 406 that are from 20 meters (m) to 30 m. Although visibility grid 400 is illustrated having a specific number of grid elements (e.g., 4 rows×10 columns), those skilled in the art will recognize that visibility grid 400 can be implemented having differing numbers of grid elements with different granularity. Further, in some aspects, the granularity of the grid elements may not be uniform (e.g., a grid element in column 1 may encompass a larger or smaller range of azimuth angles than a grid element in column 2 and/or a grid element in row 1 may encompass a larger or smaller range of range values than a grid element in row 2).

In some cases, visibility grid 400 can be used to determine the visibility of a LiDAR sensor. In some examples, visibility grid 400 may be initialized as having a default value in each grid element (e.g., a value of ‘0’ may be used to indicate that the LiDAR sensor has no visibility in any direction). In some aspects, the visibility grid 400 may be populated with a different value that indicates that the LiDAR sensor has visibility within the grid element. For example, element 410 may be populated with a value of ‘1’ to indicate that element 410 includes LiDAR point 408 and the LiDAR has visibility within field of view between 0-36 degrees along azimuth 402 and 20-30 m along range 406.

FIG. 4B illustrates an example of a visibility grid 450, according to some aspects of the present disclosure. As illustrated, visibility grid 450 is a three-dimensional visibility grid in which each grid element (e.g., voxel) corresponds to a range of azimuth values (e.g., azimuth 452); a range of range values (e.g., range 456); and a range of elevation values (e.g., elevation 454). For example, voxel 458 within visibility grid 450 corresponds to values of azimuth 452 that are from 10 degrees to 20 degrees; values of range 456 that are from 10 m to 20 m; and values of elevation 454 that are from 5 degrees to 10 degrees. As noted with respect to visibility grid 400, those skilled in the art will recognize that visibility grid 450 may be implemented having differing number of voxels and/or different granularity for each of the parameters (e.g., azimuth 452, elevation 454, and/or range 456). In one illustrative example, visibility grid 450 may be implemented with voxels having 6 degrees along azimuth 452, 2 degrees along elevation 454, and 5 m along range 456.

In some cases, visibility grid 450 can be used to determine the visibility of a LiDAR sensor. In some examples, visibility grid 450 may be initialized as having a default value in each grid element (e.g., a value of ‘0’ may be used to indicate that the LiDAR sensor has no visibility in any direction). In some aspects, the visibility grid 450 may be populated with a different value that indicates that the LiDAR sensor has visibility within the grid element. For example, voxel 458 may be populated with a value of ‘1’ to indicate that it includes a LiDAR point (e.g., detection or return) and that the LiDAR has visibility within field of view between 10-20 degrees along azimuth 452; 5-10 degrees along elevation 454; and 10-20 m along range 456.

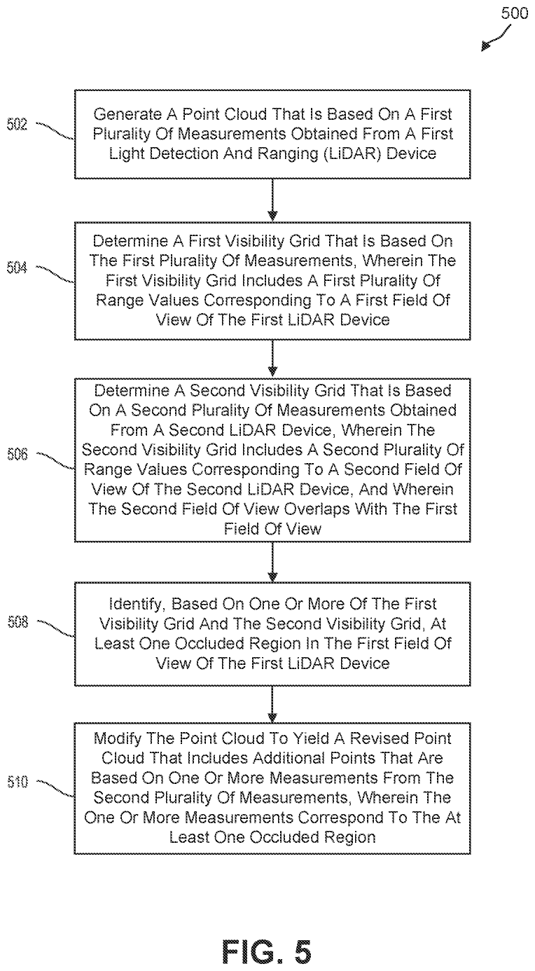

FIG. 5 illustrates a flowchart of an example process 500 for performing LiDAR point cloud stitching, according to some aspects of the present disclosure. Although the process 500 depicts a particular sequence of operations, the sequence may be altered without departing from the scope of the present disclosure. For example, some of the operations depicted may be performed in parallel or in a different sequence that does not materially affect the function of process 500. In other examples, different components of an example device or system that implements process 500 may perform functions at substantially the same time or in a specific sequence.

At step 502, the process 500 includes generating a point cloud that is based on a first plurality of measurements obtained from a first Light Detection and Ranging (LiDAR) device. For example, controller 301 can generate a point cloud that is based on measurements obtained from LiDAR 302a.

At step 504, the process 500 includes determining a first visibility grid that is based on the first plurality of measurements, wherein the first visibility grid includes a first plurality of range values corresponding to a first field of view of the first LiDAR device. For instance, controller 301 may determine visibility grid 400 and/or visibility grid 450 that is based on the measurements obtained from LiDAR 302a and includes range values (e.g., range 406 and/or range 456) corresponding to a field of view of LiDAR 302a. In some aspects, the first visibility grid corresponds to a distribution of the first field of view that is based on an azimuth range, wherein each of the first plurality of range values corresponds to a portion of the azimuth range. For example, visibility grid 400 is a two-dimensional grid having elements that correspond to the field of view of a LiDAR device based on azimuth 402 and range 406. In some cases, the distribution of the first field of view is further based on an elevation range, wherein each of the first plurality of range values corresponds to a portion of the elevation range. For instance, visibility grid 450 is a three-dimensional grid having voxels that correspond to a field of view that is further based on an elevation range (e.g., elevation 454).

At step 506, the process 500 includes determining a second visibility grid that is based on a second plurality of measurements obtained from a second LiDAR device, wherein the second visibility grid includes a second plurality of range values corresponding to a second field of view of the second LiDAR device, and wherein the second field of view overlaps with the first field of view. For example, controller 301 can determine a second visibility grid (e.g., visibility grid 400 and/or visibility grid 450) that is based on measurement obtained from LiDAR 302b, wherein FoV 306 of LiDAR 302b overlaps with FoV 304 of LiDAR 302a (e.g., see overlapping region 308). In some cases, the first LiDAR device and the second LiDAR device are associated with an autonomous vehicle (e.g., part of sensor system 104-108).

At step 508, the process 500 includes identifying, based on one or more of the first visibility grid and the second visibility grid, at least one occluded region in the first field of view of the first LiDAR device. For example, controller 301 can identify occlusion 312 based on the visibility grid associated with LiDAR 302a and/or the visibility grid associated with LiDAR 302b. That is, controller 301 can determine that LiDAR 302b has a greater range (e.g., higher visibility) than LiDAR 302a at the location (e.g., azimuth and elevation) corresponding to occlusion 312.

In some examples, identifying the at least one occluded region in the first field of view includes identifying a first range value from the first plurality of range values that is less than a second range value from the second plurality of range values, wherein the first range value and the second range value correspond to an overlapping region in the first field of view and the second field of view. For instance, controller 301 can determine that range 322a is less than range 322b, wherein range 322a corresponds to point 320a and range 322b corresponds to point 320b within overlapping region 308.

In some cases, identifying the at least one occluded region in the first field of view includes determining that a first range value from the first plurality of range values is less than a threshold range value. For example, controller 301 can determine that range 322a associated with LiDAR point 320a is less than a threshold range value (e.g., based on range measurement capability of the LiDAR device).

At step 510, the process 500 includes modifying the point cloud to yield a revised point cloud that includes additional points that are based on one or more measurements from the second plurality of measurements, wherein the one or more measurements correspond to the at least one occluded region. For example, controller 301 can modify the point cloud associated with LiDAR 302a to include point 320b that is based on measurements from LiDAR 302b, which corresponds to occlusion 312.

In some aspects, the process 500 can include allocating a first region of geographic space to the first LiDAR device and a second region of geographic space to the second LiDAR device, wherein the first region of geographic space corresponds to a first section of the first field of view and the second region of geographic space corresponds to a second section of the second field of view. For example, quadrant 206a can be allocated to LiDAR 204a and quadrant 206d can be allocated to LiDAR 204d. In some examples, the process 500 can include selecting a portion of the first plurality of measurements that correspond to the first section of the first field of view, wherein the point cloud is based on the portion of the first plurality of measurements. For instance, a point cloud can be based on a portion of measurements from LiDAR 204a that correspond to quadrant 206a. In some cases, the one or more measurements from the second plurality of measurements corresponds to measurements that are outside the second region of geographic space that is allocated to the second LiDAR device. For example, the revised point cloud can include measurements obtained by LiDAR 204d that are outside quadrant 206d that is assigned to LiDAR 204d.

FIG. 6 illustrates an example processor-based system with which some aspects of the subject technology can be implemented. For example, processor-based system 600 can be any computing device making up local computing device 110, client computing device 170, a passenger device executing the ride-hailing application 172, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: generating a point cloud that is based on a first plurality of measurements obtained from a first Light Detection and Ranging (LiDAR) device; determining a first visibility grid that is based on the first plurality of measurements, wherein the first visibility grid includes a first plurality of range values corresponding to a first field of view of the first LiDAR device; determining a second visibility grid that is based on a second plurality of measurements obtained from a second LiDAR device, wherein the second visibility grid includes a second plurality of range values corresponding to a second field of view of the second LiDAR device, and wherein the second field of view overlaps with the first field of view; identifying, based on one or more of the first visibility grid and the second visibility grid, at least one occluded region in the first field of view of the first LiDAR device; and modifying the point cloud to yield a revised point cloud that includes additional points that are based on one or more measurements from the second plurality of measurements, wherein the one or more measurements correspond to the at least one occluded region.

Aspect 2. The method of Aspect 1, wherein the first visibility grid corresponds to a distribution of the first field of view that is based on an azimuth range, wherein each of the first plurality of range values corresponds to a portion of the azimuth range.

Aspect 3. The method of Aspect 2, wherein the distribution of the first field of view is further based on an elevation range, wherein each of the first plurality of range values corresponds to a portion of the elevation range.

Aspect 4. The method of any of Aspects 1 to 3, wherein identifying the at least one occluded region in the first field of view of the first LiDAR device further comprises: identifying a first range value from the first plurality of range values that is less than a second range value from the second plurality of range values, wherein the first range value and the second range value correspond to an overlapping region in the first field of view and the second field of view.

Aspect 5. The method of any of Aspects 1 to 4, wherein identifying the at least one occluded region in the first field of view of the first LiDAR device further comprises: determining that a first range value from the first plurality of range values is less than a threshold range value.

Aspect 6. The method of any of Aspects 1 to 5, further comprising: allocating a first region of geographic space to the first LiDAR device and a second region of geographic space to the second LiDAR device, wherein the first region of geographic space corresponds to a first section of the first field of view and the second region of geographic space corresponds to a second section of the second field of view; and selecting a portion of the first plurality of measurements that correspond to the first section of the first field of view, wherein the point cloud is based on the portion of the first plurality of measurements.

Aspect 7. The method of Aspect 6, wherein the one or more measurements from the second plurality of measurements corresponds to measurements that are outside the second region of geographic space that is allocated to the second LiDAR device.

Aspect 8. The method of any of Aspects 1 to 7, wherein the first LiDAR device and the second LiDAR device are associated with an autonomous vehicle.

Aspect 9. An apparatus comprising: at least one memory; and at least one processor coupled to the at least one memory, wherein the at least one processor is configured to perform operations in accordance with any one of Aspects 1 to 8.

Aspect 10. An apparatus comprising means for performing operations in accordance with any one of Aspects 1 to 8.

Aspect 11. A non-transitory computer-readable medium comprising instructions that, when executed by an apparatus, cause the apparatus to perform operations in accordance with any one of Aspects 1 to 8.

What is claimed is:

1. A system comprising:
a memory; and
one or more processors coupled to the memory, the one or more processors being configured to:
generate a point cloud that is based on a first plurality of measurements obtained from a first Light Detection and Ranging (LiDAR) device;
determine a first visibility grid that is based on the first plurality of measurements, wherein the first visibility grid includes a first plurality of range values corresponding to a first field of view of the first LiDAR device;
determine a second visibility grid that is based on a second plurality of measurements obtained from a second LiDAR device, wherein the second visibility grid includes a second plurality of range values corresponding to a second field of view of the second LiDAR device, and wherein the second field of view overlaps with the first field of view;
identify, based on one or more of the first visibility grid and the second visibility grid, at least one occluded region in the first field of view of the first LiDAR device; and
modify the point cloud to yield a revised point cloud that includes additional points that are based on one or more measurements from the second plurality of measurements, wherein the one or more measurements correspond to the at least one occluded region.

2. The system of claim 1, wherein the first visibility grid corresponds to a distribution of the first field of view that is based on an azimuth range, wherein each of the first plurality of range values corresponds to a portion of the azimuth range.

3. The system of claim 2, wherein the distribution of the first field of view is further based on an elevation range, wherein each of the first plurality of range values corresponds to a portion of the elevation range.

4. The system of claim 1, wherein to identify the at least one occluded region in the first field of view of the first LiDAR device the one or more processors are further configured to:
identify a first range value from the first plurality of range values that is less than a second range value from the second plurality of range values, wherein the first range value and the second range value correspond to an overlapping region in the first field of view and the second field of view.

5. The system of claim 1, wherein to identify the at least one occluded region in the first field of view of the first LiDAR device the one or more processors are further configured to:
determine that a first range value from the first plurality of range values is less than a threshold range value.

6. The system of claim 1, wherein the one or more processors are further configured to:
allocate a first region of geographic space to the first LiDAR device and a second region of geographic space to the second LiDAR device, wherein the first region of geographic space corresponds to a first section of the first field of view and the second region of geographic space corresponds to a second section of the second field of view; and
select a portion of the first plurality of measurements that correspond to the first section of the first field of view, wherein the point cloud is based on the portion of the first plurality of measurements.

7. The system of claim 6, wherein the one or more measurements from the second plurality of measurements corresponds to measurements that are outside the second region of geographic space that is allocated to the second LiDAR device.

8. The system of claim 1, wherein the first LiDAR device and the second LiDAR device are associated with an autonomous vehicle.

9. A method comprising:
generating a point cloud that is based on a first plurality of measurements obtained from a first Light Detection and Ranging (LiDAR) device;
determining a first visibility grid that is based on the first plurality of measurements, wherein the first visibility grid includes a first plurality of range values corresponding to a first field of view of the first LiDAR device;
determining a second visibility grid that is based on a second plurality of measurements obtained from a second LiDAR device, wherein the second visibility grid includes a second plurality of range values corresponding to a second field of view of the second LiDAR device, and wherein the second field of view overlaps with the first field of view;
identifying, based on one or more of the first visibility grid and the second visibility grid, at least one occluded region in the first field of view of the first LiDAR device; and
modifying the point cloud to yield a revised point cloud that includes additional points that are based on one or more measurements from the second plurality of measurements, wherein the one or more measurements correspond to the at least one occluded region.

10. The method of claim 9, wherein the first visibility grid corresponds to a distribution of the first field of view that is based on an azimuth range, wherein each of the first plurality of range values corresponds to a portion of the azimuth range.

11. The method of claim 10, wherein the distribution of the first field of view is further based on an elevation range, wherein each of the first plurality of range values corresponds to a portion of the elevation range.

12. The method of claim 9, wherein identifying the at least one occluded region in the first field of view of the first LiDAR device further comprises:
identifying a first range value from the first plurality of range values that is less than a second range value from the second plurality of range values, wherein the first range value and the second range value correspond to an overlapping region in the first field of view and the second field of view.

13. The method of claim 9, wherein identifying the at least one occluded region in the first field of view of the first LiDAR device further comprises:
determining that a first range value from the first plurality of range values is less than a threshold range value.

14. The method of claim 9, further comprising:
allocating a first region of geographic space to the first LiDAR device and a second region of geographic space to the second LiDAR device, wherein the first region of geographic space corresponds to a first section of the first field of view and the second region of geographic space corresponds to a second section of the second field of view; and
selecting a portion of the first plurality of measurements that correspond to the first section of the first field of view, wherein the point cloud is based on the portion of the first plurality of measurements.

15. The method of claim 14, wherein the one or more measurements from the second plurality of measurements corresponds to measurements that are outside the second region of geographic space that is allocated to the second LiDAR device.

16. The method of claim 9, wherein the first LiDAR device and the second LiDAR device are associated with an autonomous vehicle.

17. A non-transitory computer-readable media comprising instructions stored thereon which, when executed are configured to cause a computer or processor to:
generate a point cloud that is based on a first plurality of measurements obtained from a first Light Detection and Ranging (LiDAR) device;
determine a first visibility grid that is based on the first plurality of measurements, wherein the first visibility grid includes a first plurality of range values corresponding to a first field of view of the first LiDAR device;
determine a second visibility grid that is based on a second plurality of measurements obtained from a second LiDAR device, wherein the second visibility grid includes a second plurality of range values corresponding to a second field of view of the second LiDAR device, and wherein the second field of view overlaps with the first field of view;
identify, based on one or more of the first visibility grid and the second visibility grid, at least one occluded region in the first field of view of the first LiDAR device; and
modify the point cloud to yield a revised point cloud that includes additional points that are based on one or more measurements from the second plurality of measurements, wherein the one or more measurements correspond to the at least one occluded region.

18. The non-transitory computer-readable media of claim 17, wherein the first visibility grid corresponds to a distribution of the first field of view that is based on an azimuth range, wherein each of the first plurality of range values corresponds to a portion of the azimuth range.

19. The non-transitory computer-readable media of claim 17, wherein to identify the at least one occluded region in the first field of view of the first LiDAR device the instructions are configured to cause the computer or the processor to:
determine that a first range value from the first plurality of range values is less than a threshold range value.

20. The non-transitory computer-readable media of claim 17, comprising further instructions configured to cause the computer or the processor to:
allocate a first region of geographic space to the first LiDAR device and a second region of geographic space to the second LiDAR device, wherein the first region of geographic space corresponds to a first section of the first field of view and the second region of geographic space corresponds to a second section of the second field of view; and
select a portion of the first plurality of measurements that correspond to the first section of the first field of view, wherein the point cloud is based on the portion of the first plurality of measurements.
